(19) United States
(12) Patent Application Publication
(10) Pub. No.: US 2019/0087556 A1
(43) Pub. Date: Mar. 21, 2019

(54) PORTABLE SCIENTIFIC INVESTIGATION APPARATUS AND CONTROL METHOD THEREOF

(71) Applicant: SIIONE INC., Seoul (KR)

(72) Inventors: Young-Seob LEE, Seoul (KR); Ho-Jin RYU, Seoul (KR)

(21) Appl. No.: 16/081,134

(22) PCT Filed: Apr. 2, 2017
(86) PCT No.: PCT/KR2017/003610

§ 371 Date: Aug. 30, 2018

(30) Foreign Application Priority Data
Apr. 14, 2016 (KR) 10-2016-0045775

(51) Int. Cl. G06F 21/32; G06F 21/60; G06K 9/00; H04L 29/06

(52) U.S. Cl. CPC G06F 21/32; G06F 21/60; G06K 9/00604; H04L 63/0861; G06K 9/00087; G06K 9/00013

(57) ABSTRACT

A portable scientific investigation apparatus according to an example embodiment includes an iris recognition device configured to obtain iris information of a user, a fingerprint recognition device configured to scan a fingerprint of a suspect and to extract fingerprint minutiae information from the scanned fingerprint image, a wireless communication device configured to establish a wireless communication link with a management server, and a control device configured to authenticate the user using the iris information of the user, and to obtain personal information of the suspect, which corresponds to the fingerprint minutiae information, by operating in conjunction with the management server when the user is authenticated as a registered user.

### CROSS-REFERENCE TO RELATED APPLICATIONS

This application claims the benefit under 35 U.S.C. Section 371, of PCT International Application No. PCT/KR2017/003610, filed on Apr. 2, 2017, which claimed priority to Korean Patent Application No. KR 10-2016-0045775, filed on Apr. 14, 2016, the disclosures of which are hereby incorporated by the references.

### TECHNICAL FIELD

Example embodiments relate to a portable scientific investigation apparatus and a method of controlling the portable scientific investigation apparatus.

### BACKGROUND ART

As a scientific investigation technology advances, various kinds of apparatuses for supporting a scientific investigation have been developed.

A fingerprint recognition technology that obtains personal information based on fingerprint recognition is one of the scientific investigation technologies. According to a conventional fingerprint recognition technology, a fingerprint obtained at a scene of an accident is required to be input to a system, which is located at a remote place, to perform fingerprint recognition since a security level of the system related with the fingerprint recognition technology is high. Therefore, it is difficult to recognize the fingerprint promptly, and performing the fingerprint recognition has a locational restriction.

The conventional fingerprint recognition technology is described in Korean Patent Application Publication No. 2006-0081175, Korean Patent No. 1209508, and Korean Patent Application Publication No. 2009-0064699.

### PRIOR ART DOCUMENTS

### Patent Documents

(Patent document 1) Korean Patent Application Publication No. 2006-0081175

(Patent document 2) Korean Patent No. 1209508

(Patent document 3) Korean Patent Application Publication No. 2009-0064699

### DISCLOSURE OF INVENTION

### Technical Problem

Example embodiments are to solve the problems of the conventional technology, and more particularly to provide a portable scientific investigation apparatus that is able to obtain personal information, which corresponds to a fingerprint, at a scene of an accident by operating in conjunction with a server, and a method of controlling the portable scientific investigation apparatus.

### Solution to Problem

Some example embodiments are directed to provide a portable scientific investigation apparatus. The portable scientific investigation apparatus includes an iris recognition device configured to obtain iris information of a user, a fingerprint recognition device configured to scan a fingerprint of a suspect and to extract fingerprint minutiae information from the scanned fingerprint image, a wireless communication device configured to establish a wireless communication link with a management server, a control device configured to authenticate the user using the iris information of the user, and to obtain personal information of the suspect, which corresponds to the fingerprint minutiae information, by operating in conjunction with the management server using the wireless communication device when the user is authenticated as a registered user, a display device configured to display the personal information of the suspect, an image capturing device configured to obtain a color image, and an illumination device formed around the image capturing device to irradiate at least one of infrared light, visible light, and ultraviolet light, and including a plurality of light source elements symmetrically disposed about the image capturing device. The control device includes a minutiae extractor configured to receive the color image generated by the image capturing device, and to extract fingerprint minutiae information from a fingerprint image included in the color image to provide the fingerprint minutiae information to the management server, an image editor configured to perform at least one of functions among an extension, a reduction, a rotation, a size adjustment, a flipping, a trimming, a lightness adjustment, and a brightness adjustment on the scanned fingerprint image and the color image, and an authenticator configured to perform a user authentication using at least one of or a combination of the iris information and fingerprint minutiae information of the user, or to provide each of the iris information and the fingerprint minutiae information of the user to the management server to perform the user authentication by operating in conjunction with the management server.

In some example embodiments, the control device may receive the fingerprint minutiae information from the fingerprint recognition device or extract the fingerprint minutiae information from the fingerprint image included in the color image, which is obtained by the image capturing device.

In some example embodiments, the iris recognition device, the fingerprint recognition device, and the display device may be formed on a back side of the portable scientific investigation apparatus, and the image capturing device may be formed on a front side of the portable scientific investigation apparatus, which is opposite of the back side.

In some example embodiments, the control device may restrict an authority of the user for controlling the portable scientific investigation apparatus when the user is not authenticated as the registered user.

Some example embodiments are directed to provide a method of controlling the portable scientific investigation apparatus. The method of controlling the portable scientific investigation apparatus includes obtaining the iris information of the user, authenticating the user using the iris information of the user, scanning the fingerprint of the suspect to extract the fingerprint minutiae information from the scanned fingerprint image when the user is authenticated as the registered user, and obtaining the personal information of the suspect, which corresponds to the fingerprint minutiae information, by operating in conjunction with the management server.

The solution to problem described above does not list all of features of the present inventive concept. Various means of the present inventive concept for resolving the problem will be understood in detail with reference to example embodiments described below.

### Advantageous Effects of Invention

According to example embodiments, the portable scientific investigation apparatus may obtain personal information corresponding to a fingerprint at a scene of an accident by operating in conjunction with a server.

According to example embodiments, since the portable scientific investigation apparatus restricts an authority of a user for accessing the portable scientific investigation apparatus by authenticating the user based on iris recognition, the portable scientific investigation apparatus may have a high security level while being used at the scene of an accident.

According to example embodiments, since the portable scientific investigation apparatus extracts fingerprint minutiae information directly and transmits the extracted fingerprint minutiae information to the server, data amount transmitted between the portable scientific investigation apparatus and the server may be decreased, such that an operating resource may be reduced.

### BRIEF DESCRIPTION OF DRAWINGS

FIG. 1 is a diagram for describing a portable scientific investigation apparatus according to example embodiments.

FIG. 2 is a block diagram illustrating a portable scientific investigation apparatus according to example embodiments.

FIG. 3 is a block diagram illustrating an example of a control device illustrated in FIG. 2.

FIG. 4 is a diagram illustrating an example of a back side of a portable scientific investigation apparatus according to example embodiments.

FIG. 5 is a diagram illustrating an example of a front side of a portable scientific investigation apparatus according to example embodiments.

FIG. 6 is a diagram illustrating an example of an illumination device illustrated in FIG. 5.

FIG. 7 is a flow chart illustrating an example of a method of controlling a portable scientific investigation apparatus according to example embodiments.

FIG. 8 is a flow chart illustrating another example of a method of controlling a portable scientific investigation apparatus according to example embodiments.

### BEST MODE FOR CARRYING OUT THE INVENTION

Hereinafter, various example embodiments will be described with reference to the accompanying drawings.

The present inventive concept may, however, be embodied in many different forms and should not be construed as limited to the embodiments set forth herein. Rather, these embodiments are provided so that this disclosure will be thorough and complete, and will fully convey the scope of the present inventive concept to those skilled in the art.

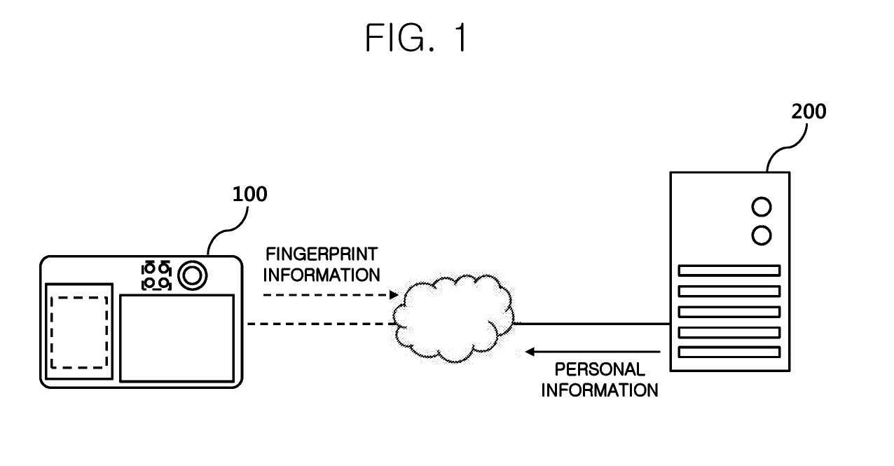

FIG. 1 is a diagram for describing a portable scientific investigation apparatus according to example embodiments.

Referring to FIG. 1, a portable scientific investigation apparatus 100 may obtain fingerprint information at a scene of an accident, and transmit the fingerprint information to a management server 200 via a wireless communication. The management server 200 may identify personal information of a suspect, which corresponds to the fingerprint information, and provide the personal information to the portable scientific investigation apparatus 100.

Therefore, the portable scientific investigation apparatus 100 may identify a fingerprint at the scene of the accident, such that an investigation and identification may be performed in real time with the portable scientific investigation apparatus 100.

The portable scientific investigation apparatus 100 may authenticate a user of the portable scientific investigation apparatus 100 based on iris recognition. Therefore, the portable scientific investigation apparatus 100 may be able to restrict an authority of the user for accessing the portable scientific investigation apparatus 100, such that a security level of the portable scientific investigation apparatus 100 may be kept in a high level.

In addition, the portable scientific investigation apparatus 100 may take a video and an image, as well as obtain fingerprint information and iris information, and provide the video and the image to the management server 200 as an evidential material.

As described above, the portable scientific investigation apparatus 100 may authenticate a user and store investigation materials in real time, as well as identify a fingerprint in real time.

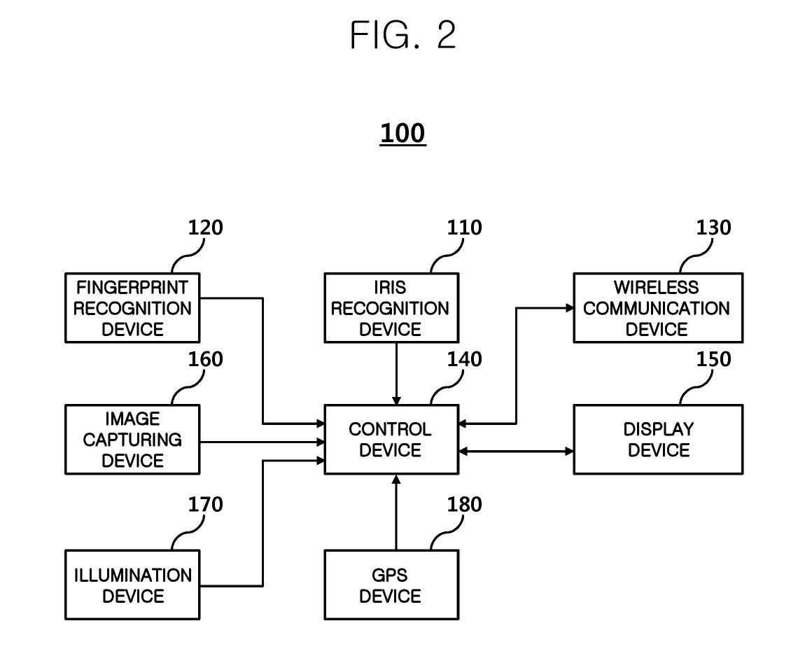

The portable scientific investigation apparatus 100 may be described in detail with reference to FIGS. 2 to 6.

FIG. 2 is a block diagram illustrating a portable scientific investigation apparatus according to example embodiments.

Referring to FIG. 2, the portable scientific investigation apparatus 100 may include an iris recognition device 110, a fingerprint recognition device 120, a wireless communication device 130, and a control device 140. In some example embodiments, the portable scientific investigation apparatus 100 may further include at least one of a display device 150, an image capturing device 160, an illumination device 170, and a global positioning system (GPS) device 180.

The iris recognition device 110 may obtain iris information of a user. The iris recognition device 110 may provide the iris information of the user to the control device 140.

The iris recognition device 110 may include an image capturing element for obtaining an iris image. In some example embodiments, the iris recognition device 110 may include a light source element that irradiates a light to an iris to obtain an iris image effectively.

The fingerprint recognition device 120 may scan a fingerprint of a suspect and extract fingerprint minutiae information from the scanned fingerprint image. The fingerprint recognition device 120 may provide the fingerprint minutiae information to the control device 140.

The fingerprint recognition device 120 may include a scan element for scanning a fingerprint and a minutiae extraction module for extracting fingerprint minutiae information from a fingerprint image. In some example embodiments, the minutiae extraction module may be included in the control device 140.

The wireless communication device 130 may establish a wireless communication link with an external apparatus including the management server 200. The wireless communication device 130 may include a mobile communication module for connecting to a mobile communication network such as 3G, 4G, etc. In some example embodiments, the wireless communication device 130 may further include various local area communication modules such as WIFI, Bluetooth, etc.

The control device 140 may authenticate the user using the iris information of the user.

In some example embodiments, the control device 140 may prestore iris information of a registered user, and authenticate the user by comparing the iris information of the user, which is obtained by the iris recognition device 110, with the iris information stored in the control device 140.

In other example embodiments, the control device 140 may transmit the iris information of the user, which is obtained by the iris recognition device 110, to the management server 200 using the wireless communication device 130, and the management server 200 may authenticate the user by comparing the iris information, which is received from the portable scientific investigation apparatus 100, with iris information of a registered user, which is prestored in the management server 200. In this case, the management server 200 may provide the authentication result to the portable scientific investigation apparatus 100.

In some example embodiments, the control device 140 may authenticate the user using at least one of or a combination of the iris information of the user and fingerprint minutiae information of the user. Although the control device 140 authenticates the user based on the iris information in the example embodiment described above, example embodiments are not limited thereto. Therefore, the control device 140 may authenticate the user either using both the iris information and the fingerprint minutiae information of the user or using one of the iris information and the fingerprint minutiae information of the user.

When the user is authenticated as the registered user, the control device 140 may provide an authority for controlling the portable scientific investigation apparatus 100 to the user. On the other hand, when the user is not authenticated as the registered user, the control device 140 may restrict the authority of the user for controlling the portable scientific investigation apparatus 100.

The control device 140 may transmit the fingerprint minutiae information, which is extracted by the fingerprint recognition device 120, to the management server 200, and obtain personal information, which corresponds to the fingerprint minutiae information, from the management server 200. The control device 140 may display the personal information, which is obtained from the management server 200, on the display device 150.

The display device 150 may display a video and an image. The display device 150 may include a touch screen for receiving a touch input from a user and a stylus pen.

The image capturing device 160 may obtain a color video and a color image. For example, the image capturing device 160 may obtain a fingerprint image by photographing a fingerprint. The control device 140 may extract fingerprint minutiae information from the fingerprint image obtained by the image capturing device 160.

That is, the portable scientific investigation apparatus 100 may scan the fingerprint of the suspect and extract the fingerprint minutiae information from the scanned fingerprint image using the fingerprint recognition device 120, or extract the fingerprint minutiae information from the fingerprint image obtained by the image capturing device 160.

Therefore, the portable scientific investigation apparatus 100 may directly scan a fingerprint from a finger of a person using the fingerprint recognition device 120 or obtain a fingerprint deposited on an object using the image capturing device 160.

The illumination device 170 may be formed around the image capturing device 160 and irradiate at least one of infrared light, visible light, and ultraviolet light, such that the illumination device 170 may irradiate appropriate light for capturing the fingerprint image according to various conditions. A brightness of the light irradiated from the illumination device 170 may be adjusted by the user's control.

The GPS device 180 may generate positional information of the portable scientific investigation apparatus 100. The GPS device 180 may include a GPS module. In some example embodiments, the GPS device 180 may generate the positional information based on connectivity information of the local area communication module (e.g., a WIFI module) included in the wireless communication device 130.

In some example embodiments, the control device 140 may provide information obtained by the iris recognition device 110, the fingerprint recognition device 120, and the image capturing device 160 to the management server 200 as an evidential material. The control device 140 may incorporate forgery prevention data (e.g., hash data, a watermark, etc.) into data obtained by the iris recognition device 110, the fingerprint recognition device 120, and the image capturing device 160, and then provide the data to the management server 200 as an evidential material.

In some example embodiments, the control device 140 may provide an image editing function. For example, the control device 140 may perform at least one of functions among an extension, a reduction, a rotation, a size adjustment, a flipping, a trimming, a lightness adjustment, and a brightness adjustment on the fingerprint image, which is scanned by the fingerprint recognition device 120, or the color image, which is captured by the image capturing device 160. The user may adjust the fingerprint image and edit the evidential material using the image editing function described above.

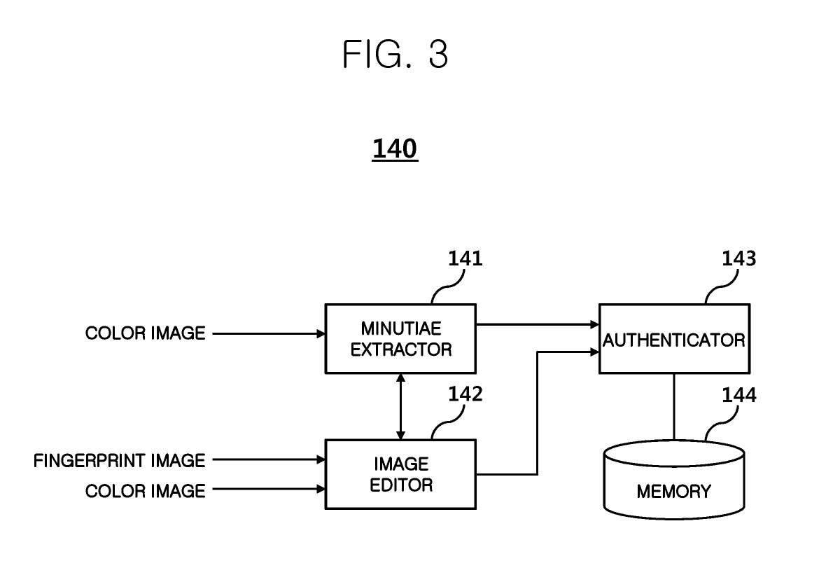

FIG. 3 is a block diagram illustrating an example of a control device illustrated in FIG. 2.

Referring to FIG. 3, the control device 140 may include a minutiae extractor 141, an image editor 142, and a memory 144. In some example embodiments, the control device 140 may further include an authenticator 143.

The minutiae extractor 141 may receive the color image generated by the image capturing device 160 and extract fingerprint minutiae information from a fingerprint image included in the color image.

The minutiae extractor 141 may provide the fingerprint minutiae information to the management server 200 using the wireless communication device 130. In some example embodiments, the minutiae extractor 141 may provide the fingerprint minutiae information to the authenticator 143, and the authenticator 143 may use the fingerprint minutiae information in a user authentication.

The image editor 142 may edit the fingerprint image, which is scanned by the fingerprint recognition device 120, and the color image, which is captured by the image capturing device 160. The image editor 142 may perform at least one of functions among an extension, a reduction, a rotation, a size adjustment, a flipping, a trimming, a lightness adjustment, and a brightness adjustment on an image according to the user's control. The image editor 142 may provide the edited fingerprint image and the edited color image to the minutiae extractor 141. In this case, the minutiae extractor 141 may extract fingerprint minutiae information from the edited fingerprint image and the edited color image provided from the image editor 142.

The authenticator 143 may perform a user authentication based on the iris information provided from the iris recognition device 110. In some example embodiments, the authenticator 143 may perform the user authentication using the iris information and/or the fingerprint minutiae information.

The authenticator 143 may authenticate the user directly based on data stored in the memory 144 or provide related data to the management server 200 to authenticate the user by operating in conjunction with the management server 200.

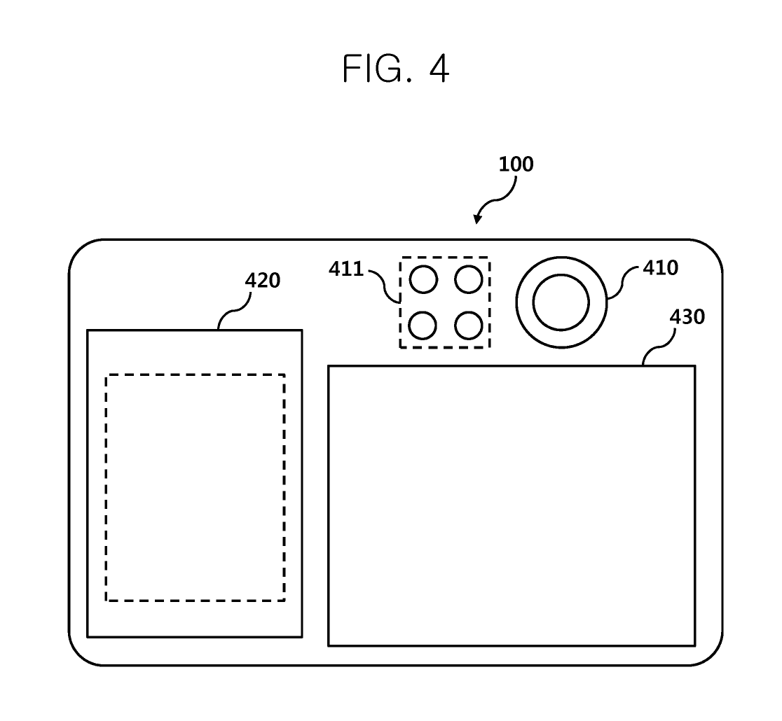

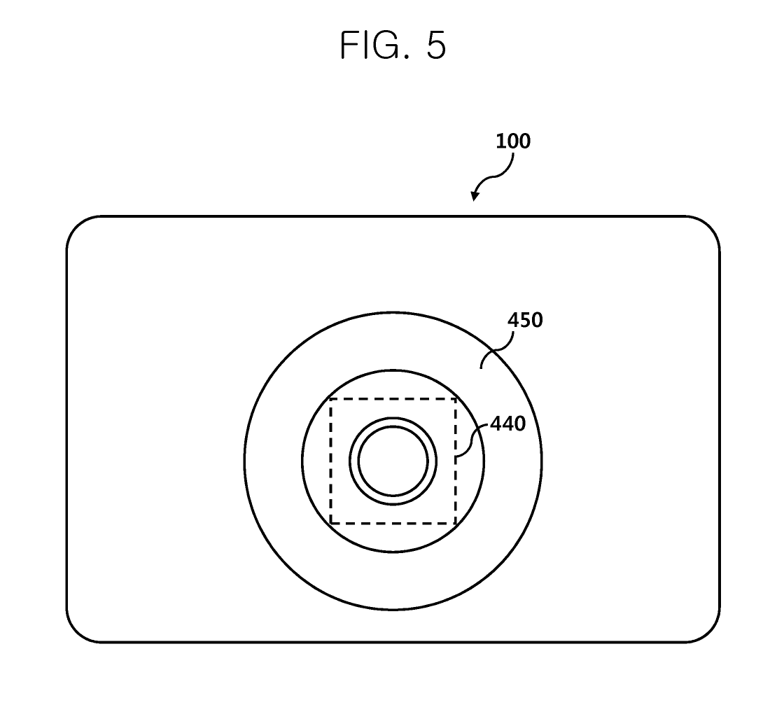

FIG. 4 is a diagram illustrating an example of a back side of a portable scientific investigation apparatus according to example embodiments, and FIG. 5 is a diagram illustrating an example of a front side of a portable scientific investigation apparatus according to example embodiments.

Referring to FIG. 4, the iris recognition device 410, the fingerprint recognition device 420, and the display device 430 may be formed on a back side of the portable scientific investigation apparatus 100.

An iris recognition light source 411, which irradiates light for iris recognition, may be formed near the iris recognition device 410.

While the iris recognition device 410 operates, the iris of the user may be required to be positioned at the center of the iris recognition device 410 to recognize the iris of the user effectively, and a captured image of the iris recognition device 410 may be displayed on the display device 430 such that the convenience of the iris recognition may be increased. That is, since the iris recognition device 410 and the display device 430 are formed on a same side, the convenience of the iris recognition may be increased.

In addition, since the fingerprint recognition device 420 is also formed on the same side as the display device 430, the user may check a result of the fingerprint recognition visually conveniently.

As illustrated in FIG. 5, the image capturing device 440 may be formed on a front side of the portable scientific investigation apparatus 100. Since the image capturing device 440 is formed on the front side, which is opposite of the back side on which the display device 430 is formed, the user may check an image, which is captured by the image capturing device 440, on the display device 430 conveniently.

The illumination device 450 may be formed around the image capturing device 440.

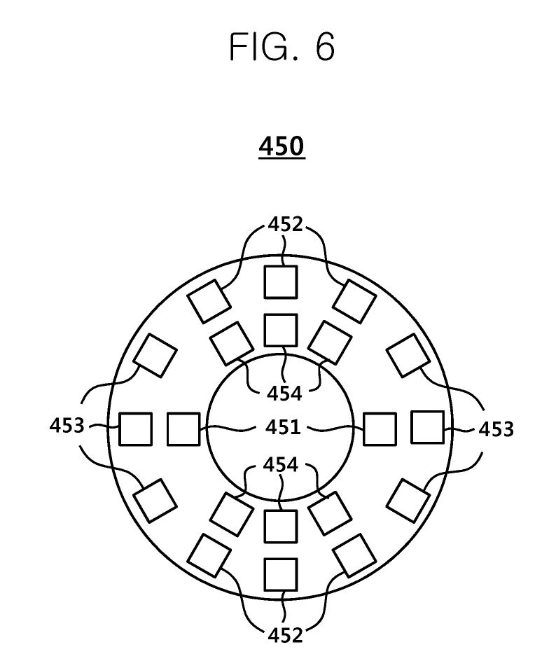

FIG. 6 is a diagram illustrating an example of an illumination device illustrated in FIG. 5.

The illumination device 450 may include various light source elements. For example, the illumination device 450 may include at least one of a white light source element 451, an ultraviolet light source element 452, a visible light source element 453, and an infrared light source element 454.

In the illustrated example embodiment, the illumination device 450 includes a plurality of white light source elements 451, a plurality of ultraviolet light source elements 452, a plurality of visible light source elements 453, and a plurality of infrared light source elements 454.

The illumination device 450 may include a plurality of white light source elements 451, a plurality of ultraviolet light source elements 452, a plurality of visible light source elements 453, and a plurality of infrared light source elements 454, and the plurality of light source elements may be symmetrically disposed.

Therefore, when the image capturing device 440 is located in a concentric circle of the illumination device 450, the illumination device 450 may irradiate light uniformly on a target while the image capturing device 440 captures an image of the target. The plurality of light source elements included in the illumination device 450 may be symmetrically disposed about the image capturing device 440.

The ultraviolet light source element 452 may irradiate light having a wavelength of 365 nm, the visible light source element 453 may irradiate light having a wavelength of 450 nm, and the infrared light source element 454 may irradiate light having a wavelength of 940 nm.

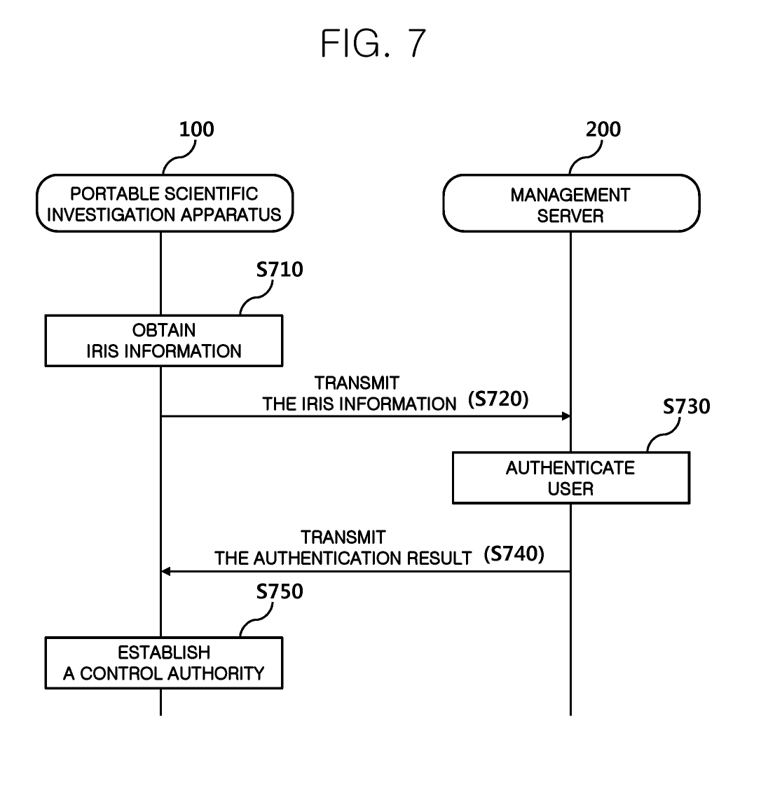

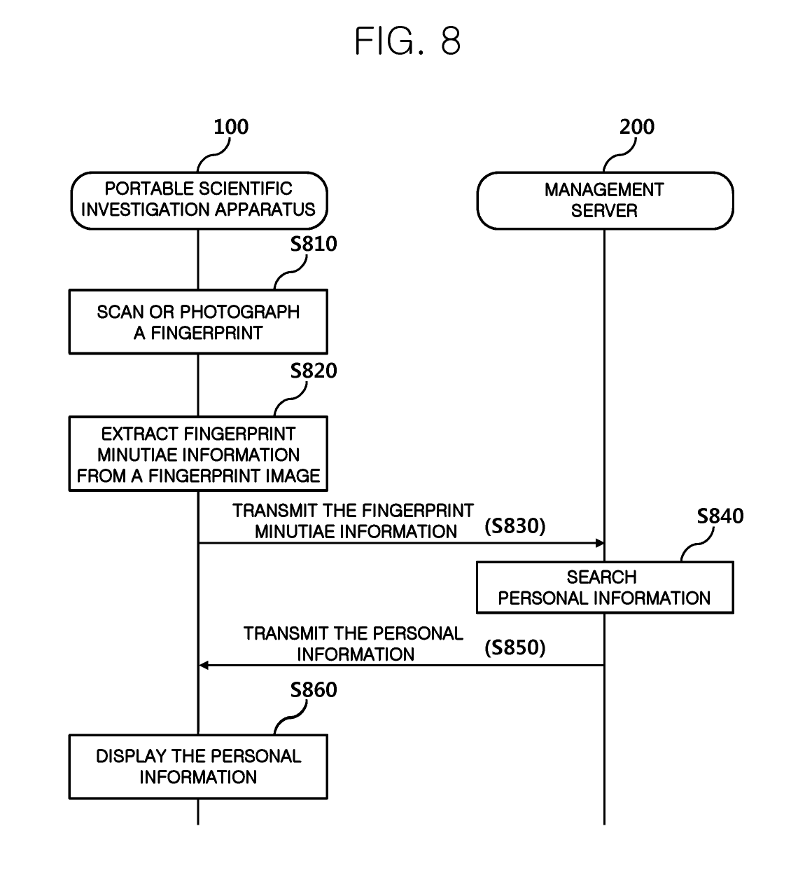

Hereinbefore, the portable scientific investigation apparatus is described with reference to FIGS. 1 to 6. Hereinafter, a method of controlling the portable scientific investigation apparatus will be described with reference to FIGS. 7 and 8. The method of controlling the portable scientific investigation apparatus described below will be understood easily from the portable scientific investigation apparatus described with reference to FIGS. 1 to 6.

FIG. 7 is a flow chart illustrating an example of a method of controlling a portable scientific investigation apparatus according to example embodiments.

Referring to FIG. 7, the portable scientific investigation apparatus 100 may obtain the iris information of the user (S710).

The portable scientific investigation apparatus 100 may authenticate the user using the iris information of the user. For example, the portable scientific investigation apparatus 100 may transmit the iris information to the management server 200 (S720). The management server 200 may authenticate the user based on the iris information received from the portable scientific investigation apparatus 100 (S730), and provide the authentication result to the portable scientific investigation apparatus 100 (S740).

The portable scientific investigation apparatus 100 may establish a control authority of the portable scientific investigation apparatus 100 for the user based on the authentication result (S750). For example, when the user is authenticated as the registered user, the portable scientific investigation apparatus 100 may provide the personal information of the suspect based on the fingerprint information of the suspect.

FIG. 8 is a flow chart illustrating another example of a method of controlling a portable scientific investigation apparatus according to example embodiments.

Referring to FIG. 8, the portable scientific investigation apparatus 100 may generate the fingerprint image by scanning the fingerprint of the suspect or photographing a fingerprint deposited on an object (S810).

The portable scientific investigation apparatus 100 may extract the fingerprint minutiae information from the fingerprint image (S820).

The portable scientific investigation apparatus 100 may transmit the fingerprint minutiae information to the management server 200 (S830), and the management server 200 may search the personal information of the suspect using the fingerprint minutiae information (S840). The management server 200 may transmit the personal information of the suspect to the portable scientific investigation apparatus 100 (S850), and the portable scientific investigation apparatus 100 may display the personal information of the suspect (S860).

The foregoing is illustrative of various example embodiments and is not to be construed as limited to the specific example embodiments disclosed and the figures attached, those skilled in the art will readily appreciate that many modifications are possible in the example embodiments without materially departing from the novel teachings and advantages of the present inventive concept, and the modifications to the disclosed example embodiments, as well as other example embodiments, are intended to be included within the scope of the appended claims.

### DESCRIPTION OF REFERENCE NUMERALS

100: a portable scientific investigation apparatus
200: a management server
110: an iris recognition device
120: a fingerprint recognition device
130: a wireless communication device
140: a control device
150: a display device
160: an image capturing device
170: an illumination device
180: a GPS device
141: a minutiae extractor
142: an image editor
143: an authenticator
144: a memory
410: an iris recognition device
411: an iris recognition light source
420: a fingerprint recognition device
430: a display device
440: an image capturing device
450: an illumination device
451: a white light source element
452: an ultraviolet light source element
453: a visible light source element
454: an infrared light source element

1. A portable scientific investigation apparatus, comprising:
an iris recognition device configured to obtain iris information of a user;
a fingerprint recognition device configured to scan a fingerprint of a suspect and to extract fingerprint minutiae information from the scanned fingerprint image;
a wireless communication device configured to establish a wireless communication link with a management server;
a control device configured to authenticate the user using the iris information of the user, the controller being configured to obtain personal information of the suspect, which corresponds to the fingerprint minutiae information, by operating in conjunction with the management server using the wireless communication device when the user is authenticated as a registered user;
a display device configured to display the personal information of the suspect;
an image capturing device configured to obtain a color image; and
an illumination device formed around the image capturing device to irradiate at least one of infrared light, visible light, and ultraviolet light, wherein the illumination device includes a plurality of light source elements symmetrically disposed about the image capturing device,
wherein the control device includes:
a minutiae extractor configured to receive the color image generated by the image capturing device, the minutiae extractor being configured to extract fingerprint minutiae information from a fingerprint image included in the color image to provide the fingerprint minutiae information to the management server;
an image editor configured to perform at least one of functions among an extension, a reduction, a rotation, a size adjustment, a flipping, a trimming, a lightness adjustment, and a brightness adjustment on the scanned fingerprint image and the color image; and
an authenticator configured to perform a user authentication using at least one of or a combination of the iris information and fingerprint minutiae information of the user, or to provide each of the iris information and the fingerprint minutiae information of the user to the management server to perform the user authentication by operating in conjunction with the management server.

2. The portable scientific investigation apparatus of claim 1, wherein the control device receives the fingerprint minutiae information from the fingerprint recognition device or extracts the fingerprint minutiae information from the fingerprint image included in the color image, which is obtained by the image capturing device.

3. The portable scientific investigation apparatus of claim 1, wherein the iris recognition device, the fingerprint recognition device, and the display device are formed on a back side of the portable scientific investigation apparatus, and the image capturing device is formed on a front side of the portable scientific investigation apparatus, which is opposite of the back side.

4. The portable scientific investigation apparatus of claim 1, wherein the control device restricts an authority of the user for controlling the portable scientific investigation apparatus when the user is not authenticated as the registered user.

5. A method of controlling the portable scientific investigation apparatus of claim 1, comprising:
obtaining the iris information of the user;
authenticating the user using the iris information of the user;
scanning the fingerprint of the suspect to extract the fingerprint minutiae information from the scanned fingerprint image when the user is authenticated as the registered user; and
obtaining the personal information of the suspect, which corresponds to the fingerprint minutiae information, by operating in conjunction with the management server.
